(19) United States
(12) Patent Application Publication
(10) Pub. No.: US 2019/0043025 A1
(43) Pub. Date: Feb. 7, 2019

(54) GENETIC ALGORITHMS IN BLOCKCHAIN SPACE

(71) Applicant: INTUIT INC., Mountain View, CA (US)

(72) Inventor: Aram MARTIROSYAN, Woodland Hills, CA (US)

(21) Appl. No.: 15/667,137

(22) Filed: Aug. 2, 2017

(51) Int. Cl. G06Q 20/06; G06F 9/455; H04L 9/08

(52) U.S. Cl. CPC G06Q 20/065; G06Q 2220/00; H04L 9/088; G06F 9/45558

(57) ABSTRACT

Techniques are disclosed for managing digital assets. One embodiment presented herein includes a computer-implemented method, which includes receiving one or more optimization criteria from a user for optimizing a portfolio of digital assets. The method further includes generating a genome population comprising a plurality of genomes, each of which represents a solution for optimizing the portfolio of digital assets. The method further includes selecting two parent genomes from the genome population, mating the two parent genomes to produce a child genome, mutating the child genome, adding the child genome to the genome population, and removing a number of genomes from the genome population. The method further includes, upon determining, based on the one or more optimization criteria, that a genome in the genome population represents an optimal solution, performing at least one of buying, selling, and trading of digital assets according to the solution represented by the genome.

### FIELD

The present disclosure relates to techniques for digital asset management, and more specifically, to using genetic algorithms in blockchain space to optimize digital asset management.

### BACKGROUND

Money, which comprises currency in a plurality of different forms, is a measure of value. Recent innovations have expanded the definition of money into the realm of digital assets and cryptocurrencies, which represent stores of value in discrete data structures handled by modified peer-to-peer networking algorithms and other computer-implemented regimes.

Generally, digital currency systems comprise a server including a database for associating an account with a unique alphanumeric code, the account comprising a record of funds stored in an electronic file or record that designates the sum of money as particularly associated with the alphanumeric code. The unique alphanumeric code may be randomly generated by the server or provided by a user.

Currency systems deal with dynamic information which may change based on time. For example, the dynamic information may be encrypted in such a way to that the encryption changes over time. Dynamic information may include, for example, a dynamic number that is used as a credit card number, debit card number, and/or payment verification code. Dynamic information may also include, for example, a student identification number or medical identification number. Dynamic information may also include, for example, account names. Payment information may be communicated in a variety of ways, such as an IC chip, RFID antenna, magnetic emulator or encoder, and near field communication (NFC).

A cryptocurrency may generally be defined as a digital medium of exchange where units are produced according to a predefined, fixed formula (typically based on cryptography), yielding a decentralized system of currency creation and distribution. Only a limited amount of cryptocurrency is produced collectively by an entire cryptocurrency system, and no entity may accelerate, slow or in any other way interfere with the production of money.

A large number of cryptocurrency specifications currently exist, most of which are similar to and derived from the first fully implemented cryptocurrency protocol, Bitcoin, which began trading in 2009. Cryptocurrencies are generally maintained in wallets, which are software clients operating on computers and personal electronic devices. Examples of wallets include the Bitcoin-QT client, Electrum, Armory, Bitcoinwallet, etc. Cryptocurrency may be managed on a cloud-based system such as a blockchain, which comprises a shared, immutable digital ledger.

As digital assets such as cryptocurrencies continue to grow in prominence and variety, it is becoming increasingly difficult to manage a portfolio of such digital assets. For example, an individual may maintain a portfolio of digital assets (similar to a traditional investment portfolio made up of stocks, bonds, etc.), and may need to make regular decisions about whether to buy, sell, or trade particular digital assets (e.g., cryptocurrencies) based on a variety of factors (e.g., digital market conditions, hash rate, transaction volume, and the like). Due to the vast scope of digital assets available and the wealth of data to be analyzed, determining an ideal digital portfolio disposition can be time and resource intensive. As such, there is a need for more efficient means of managing digital assets.

### SUMMARY

One embodiment presented herein includes a computer implemented method for managing digital assets of a user. The method generally includes receiving one or more optimization criteria from a user for optimizing a portfolio of digital assets. The method further includes generating a genome population comprising a plurality of genomes, each of which represents a solution for optimizing the portfolio of digital assets. The method further includes selecting two parent genomes from the genome population, mating the two parent genomes to produce a child genome, mutating the child genome, adding the child genome to the genome population, and removing a number of genomes from the genome population. The method further includes determining, based on the one or more optimization criteria, whether any genome in the genome population represents an optimal solution. The method further includes, upon determining that a genome in the genome population represents an optimal solution, performing at least one of buying, selling, and trading digital assets according to the solution represented by the genome.

Additional embodiments include a computing device having a processor and a memory storing one or more application programs configured to perform the methods disclosed herein and a computer-readable storage medium storing instructions, which when executed on a processor perform the methods disclosed herein.

### BRIEF DESCRIPTION OF THE DRAWINGS

FIG. 1 illustrates an example of a computing environment used for digital asset management, according to one embodiment.

FIG. 2 illustrates components of an asset manager, according to one embodiment.

FIG. 3 illustrates components of a data store, according to one embodiment.

FIG. 4 illustrates example operations for managing digital assets using genetic algorithms in a distributed system, according to one embodiment.

FIG. 5 illustrates an example computing system used to manage digital assets, according to one embodiment.

### DETAILED DESCRIPTION

Embodiments presented herein provide techniques for managing digital assets. More specifically, embodiments presented herein involve the use of genetic algorithms in distributed systems to manage digital assets.

For example, a user may wish to optimize a portfolio of digital assets (e.g., bitcoin and other cryptocurrencies) based on certain optimization criteria. The user may, via a client device, access an asset manager (e.g., a remotely hosted web service accessed through a client application) and specify the optimization criteria (e.g., digital assets to choose from, target portfolio value, target cash value, maximum tax liability, etc.). The asset manager then uses genetic algorithms executing on a distributed system (e.g., a blockchain) to determine an optimal disposition of a portfolio of digital assets for the user based on the optimization criteria.

Algorithms based upon principles of genetics (e.g., natural selection, the process that drives biological evolution) explore a large solution space of a particular problem and quickly move towards the subspace which contains the best solution according to user-defined criteria. The solution space of a problem may comprise all possible solutions to the problem, or at least a subset of all possible solutions to the problem within a scope defined by the user. In the context of digital asset management, the solution space may comprise, for example, all of the different ways in which the user's portfolio of digital assets may potentially be distributed. For example, the asset manager may generate an initial population of “genomes,” each of which represents a potential portfolio distribution. A genome may, for instance, comprise a vector made up of values, each of which represents a change in a percentage of each digital asset in a portfolio containing a number of digital assets. Because the entire solution space may be very large, the initial population may be generated through random production of genomes, and may not comprise the entire solution space.

The genome population is modified using a genetic algorithm executing on one or more computing devices, including introducing into the genome population new vectors (referred to as offspring or children) derived from other vectors (referred to as parents), including the original or previously existing vectors. The genome population is modified until at least one vector represents a change in the percentage of each asset such that the disposition of each asset is in accordance with the percentage change that most nearly satisfies or optimizes one or more criteria, such as the generation of a desired amount of cash, minimization of taxes, or the like.

Modifying the genome population can include determining a fitness of each genome (vector) based on one or more criteria functions pertaining to the disposition of an asset in the asset portfolio. The criteria functions provide a way of measuring the degree to which the disposition of assets in accordance with a genome vector satisfies the various criteria defined by the user. Various vectors are selected as parent vectors from the first set of vectors based on their fitness and then combined to obtain a second set of vectors, which are the offspring of the parent vectors. The resulting offspring vectors are preferably mutated and used to replace selected ones of vectors in the genome population.

Because the solution space of potential dispositions of digital assets may be extremely large (e.g., due to the increasing number of digital assets available on private and public interoperable distributed systems), executing the genetic algorithm on a single computing device may become inefficient due to limited resources. As such, embodiments of the present disclosure involve executing genetic algorithms on a distributed system such as a blockchain. A blockchain is a distributed system which comprises a plurality of nodes acting collectively as an immutable digital ledger, in which a continuously growing list of records, called blocks, is maintained. Each block comprises a record of a transaction performed on the blockchain and contains a timestamp and a link to a previous block (e.g., Merkle/Hash Tree). Blockchains are generally managed by peer-to-peer networks which collectively adhere to an established protocol for validating each new block and are designed to be inherently resistant to modification of data. Once recorded, the data in any given block cannot be modified without the alteration of all subsequent blocks and the involvement of the network.

Digital assets are commonly maintained on blockchains (e.g., bitcoin), allowing for permanent and verifiable records of all transactions related to the digital assets. Blockchains are also used to implement distributed computing platforms featuring scripting functionality, such as Turing-complete virtual machines (e.g., Ethereum Virtual Machine), which facilitate online contractual agreements. A computational system is considered Turing-complete if it can compute every Turing-computable function (e.g., “if” and “goto” statements, “branch if zero” instructions, etc.). Executing genetic algorithms for digital asset management on a distributed system such as a blockchain-implemented Turing-complete digital machine allows for a solution to be achieved in a much shorter amount of time. Because computations are distributed across a plurality of nodes in the distributed system, the genome population is able to be larger, and the subsequent modification and shrinking of the population towards an optimal solution is accomplished more efficiently.

Scripting functionality on a Turing-complete virtual machine may be used to implement “smart contracts,” which are computerized transaction protocols that execute the terms of a contract (e.g., involving the disposition of digital assets). In some embodiments, smart contracts are used by the digital asset manager to identify and implement an optimal disposition of digital assets. For example, a genetic algorithm may be used to identify an optimal solution comprising combinations of smart contracts to execute, and then the smart contracts may be executed according to the identified optimal solution.

The present disclosure may be embodied in various forms, including computer program products, methods, and systems, special or general purpose computing devices or apparatus, online services or systems, users interfaces, etc.

By employing a genetic algorithm executed on a distributed system in order to find a solution for optimizing a set of criteria, such as generating a certain amount of cash, in the disposition of a digital asset portfolio, it is possible to search a potentially intractable solution space for an optimal solution in an acceptable amount of time.

One of ordinary skill in the art will recognize that the techniques described herein may be adapted for use by a broad variety of software applications, online or web services, software features, or support services where genetic algorithms may be used to facilitate management of the disposition of assets. Additionally, it should be noted that although, in certain examples described herein, particular computing devices or components are described as performing certain tasks (e.g., receiving user criteria, generating genomes, selecting parents, producing children, reducing genome population, analyzing genomes, implementing digital asset disposition, etc.), such tasks may be performed by one or more additional computing devices or components (e.g., connected via a wired or wireless network).

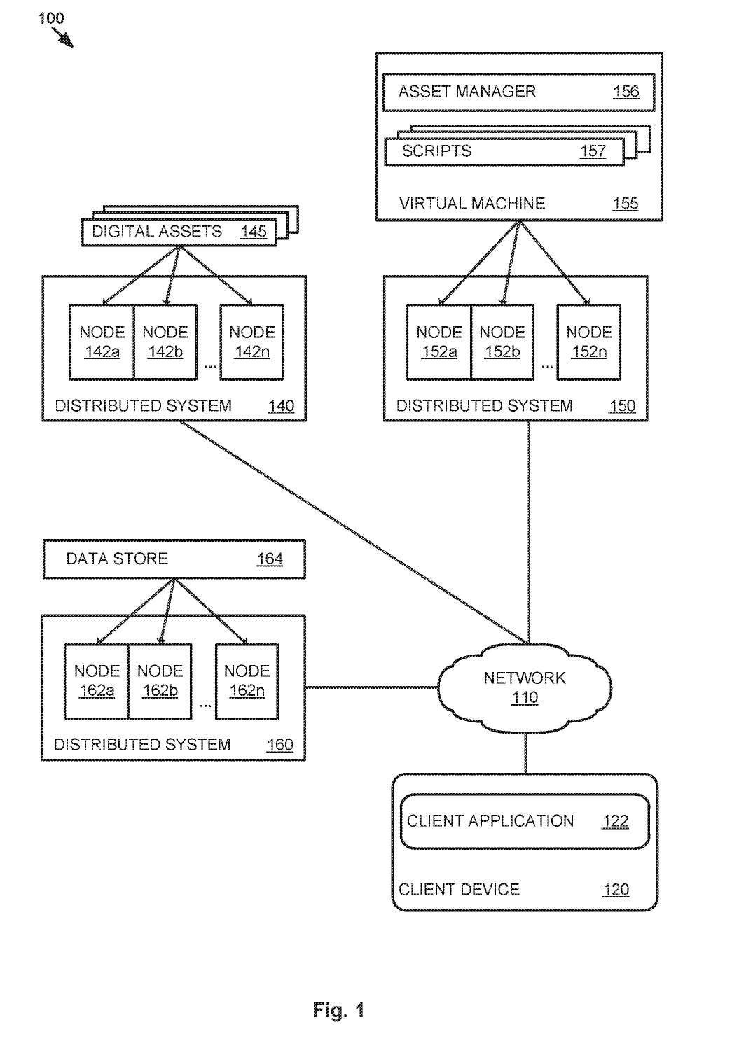

FIG. 1 illustrates an example of a computing environment 100 used to manage disposition of digital assets, according to one embodiment. As shown, the computing environment 100 includes client device 120, as well as distributed systems 140, 150, and 160. The network 110, in general, may be a wide area network (WAN), local area network (LAN), wireless LAN (WLAN), personal area network (PAN), a cellular network, etc. In a particular embodiment, the network 110 is the Internet.

Client device 120 is representative of a computing system, such as a desktop or laptop computer, tablet, or mobile phone, hosting applications used to access remote services such as asset manager 156. For example, client device 120 includes a client application 122. The client application 122 is included to be representative of a component of a client server application (or other distributed application) which can communicate with asset manager 156 over network 110. Client application 122 may be a “thin” client where the processing is largely directed by the client application 122, but performed by computing systems of the asset manager 156, or may be a conventional software application installed on client device 120.

In one embodiment, client application 122 communicates with asset manager 156. For example, client application 122 may provide software which allows a user to define criteria for the management of the user's digital assets (e.g., types of digital assets, etc.) through a user interface. In some embodiments, client application 122 allows the user to establish a user account with asset manager 156, and the user account may be used to store the user's personal information (e.g., physical location, age, gender, income, etc.) and criteria for optimization of a portfolio of digital assets.

Distributed systems 140, 150, and 160 may each comprise a plurality of nodes (e.g., separate computing systems such as servers) sharing resources and capabilities in order to provide users with a single and integrated coherent network. In some embodiments, one or more of distributed systems 140, 150, and 160 comprise blockchains. In other embodiments, distributed systems 140 and 150 comprise blockchains, and distributed system 160 comprises a distributed storage network (e.g., InterPlanetary File System (IPFS) or other type of distributed file system). While three distributed systems, 140, 150, and 160, are depicted, the functionality described with respect to these distributed systems may be implemented by a single computing system or any number of distributed systems.

For example, distributed system 140 may comprise a blockchain which maintains an immutable ledger of transactions corresponding to one or more digital assets 145. Nodes 142a-n may comprise computing systems (e.g., servers) which share resources to provide a unified digital ledger of transactions related to digital assets 145. Digital assets 145 may, for example, comprise one or more types of cryptocurrency (e.g., bitcoin, blackcoin, etc.). The user of client device 120 may, for example, maintain a portfolio of digital assets 145 stored on distributed system 140, and the user's portfolio may be managed by asset manager 156. Users may perform transactions (e.g., buying and selling) on digital assets 145, and records of the transactions may be permanently stored in distributed system 140.

Distributed system 150 may comprise a blockchain (made up of nodes 152a-n) which executes a virtual machine 155. Distributed system 150 may distribute processing among nodes 152a-n (e.g., according to sharding techniques). In some embodiments, virtual machine 155 comprises a decentralized Turing-complete virtual machine (e.g., Ethereum Virtual Machine) which executes a plurality of scripts 157 (e.g., smart contracts). Scripts 157 may perform transactions, such as buying and selling digital assets 145. Distributed system 150 also includes an asset manager 156, which provides services related to the management of digital assets 145.

For example, asset manager 156 may receive criteria from a user (e.g., entered by a user through a user interface of client application 122) regarding the management of the user's portfolio of digital assets 145. The criteria may include, for instance, the identities and amounts of the user's current digital assets, the types of digital assets which the user would like to invest in, a target overall monetary value of the user's portfolio, a target cash value, a maximum amount of tax that the user would like to pay, and the like. Asset manager 156 may then use these criteria, along with any other relevant information (e.g., the user's profile information, such as geographic location, age, income, etc.), to begin running a genetic algorithm in order to optimize the user's portfolio of digital assets 145.

In some embodiments, if the user already has an existing portfolio of digital assets 145, the asset manager 156 retrieves information about the portfolio from a data store containing user information, such as a local database, a remote database (e.g., data store 164), or another database maintained on the Internet by a financial services online provider. Again, depending on the implementation, the user interacts with the asset manager 156 through client application 122 to designate the portfolio from a number of other portfolios (e.g., based on user information such as a username and password or Elliptic Curve Digital Signature Algorithm (ECDSA) private key), or the user may construct the portfolio by selecting particular digital assets from a larger portfolio. For obtaining the user's criteria, asset manager 156 may provide the user with a graphical or textual user interface through client application 122 presenting each possible criteria and having the user select them, specify their values, and/or rank them in order of importance, or use a sequence of pairwise comparisons to determine the user's implicit ranking, or provide the list of the criteria, along with a control for each to allow the user to set the weight (e.g., 1 to 10) of the criteria, which are then internally normalized. In addition, the user can select which criteria to satisfy and which to ignore (either by removing the criteria from the later computation process, or by giving such functions a weighting of 0). Input of the target monetary value of the portfolio or target cash value can likewise be made via a text or graphical user interface. If the user simply wants portfolio rebalancing without generation of any cash, then the user can weight the cash generation criterion as zero (0).

Then, an initial genome population is generated by asset manager 156. The genome population comprises a plurality of genomes that are in the form of vectors. An initial genome population of around 100 genomes may be useful, but more or fewer can be used. Because distributed system 150 allows for asset manager 156 to distribute processing across nodes 152a-n, a much larger initial genome population may be generated. In the context of the present disclosure, the terms “vector” and “genome” will be used interchangeably herein. Each genome comprises a plurality of “alleles,” one allele for each digital asset in the initial asset portfolio. Each allele corresponds to a digital asset disposition value for each digital asset, representing how each digital asset should be disposed of.

According to one embodiment of the present disclosure, each allele represents a percentage of each digital asset to be sold. Assume, for example, that the initial digital asset portfolio includes four different digital assets A, B, C, and D, each constituting 10%, 15%, 25%, and 50%, respectively, of the initial digital asset portfolio, in terms of their cash value, say $200, $300, $500, and $1,000 respectively in a portfolio having a total value of $2,000. For instance, a genome for this portfolio of <100, 20, 40, 50> has four alleles, 100, 20, 40, and 50, which means that 100% of digital asset A, 20% of digital asset B, 40% of digital asset C, and 50% of digital asset D need to be sold from the initial digital asset portfolio to generate the desired amount of cash. That is, the allele of ‘100’ indicates to sell 100% of digital asset A, i.e., 10% (100% of 10%, or $200) of the entire cash value of the asset portfolio. The allele of ‘20’ indicates to sell 20% of digital asset B, 3% (20% of 15%, or $60) of the entire cash value of the portfolio, and so forth for the other alleles.

Alternatively, according to another embodiment of the present disclosure, each allele in the genome represents a percentage of each asset to keep rather than sell. In this case, in the above example, the genome <100, 20, 40, 50> indicates to keep 100% of digital asset A, 20% of digital asset B, 40% of digital asset C, and 50% of digital asset D, and sell the rest in order to generate the desired amount of cash and/or other criteria. Thus, the particular coding of the alleles (sell or keep) is merely a design consideration.

According to one embodiment, the genomes in the initial genome population are randomly generated. The random generation of genomes may be spread across the nodes 152a-n which make up distributed system 150. In one embodiment, each allele in a genome comprises a plurality of binary bits representing the digital asset disposition value. The asset manager 156 may, for instance, utilize a bit-string uniform procedure in randomly generating the genomes, by assigning 0 or 1 to each bit in the genome with equal probability. To this end, the asset manager 156 first chooses randomly a bit density d from a uniform distribution, wherein 0<=d<=1. Then, the asset manager 156 randomly sets each bit of each allele to one (1) with a probability of d. This will result in genomes evenly distributed in the binary space. It should be noted that this initialization is with respect to the entire genome treated as single bit string, and temporarily ignoring the separation of the individual alleles. Thus, for example, if each allele is represented by a 32-bit value, and there are 10 alleles, then the genome is treated as 320 bit string during the initialization process. The values of each allele are then the values of each corresponding 32-bit word in the bit string.

Alternatively in accordance with another embodiment, selected ones of the genomes in the initial genome population are initialized with predetermined values, thereby giving structured data for the asset manager 156 to draw on. For example, including a genome of all zeros (0) and a genome of all ones (1) in the initial genome population allows the asset manager 156 to find solutions at the very ends of the solution space. Any number of other fixed genomes may be added to the initial population, though this is likely to affect the quality of the overall search of the solution space.

The alleles are preferably represented by either an unsigned integer or a floating-point number. If an unsigned integer is used according to one embodiment, the integer represents the numerator of a quotient, the implicit denominator being the maximum unsigned integer that can be stored in a certain number of bits used by the computer. Therefore, the resultant quotient will be a rational number in the range of 0.0 to 1.0 in floating point form, which represents the asset disposition percentage for the corresponding asset. A very simple example will suffice: Assume that the maximum number of bits is 8, in which case the implicit denominator is 255 or “11111111” in binary form. Thus, for an allele that ultimately represents disposition of 64/255 (approximately 25%) of the digital asset, the numerator is 64 or “1000000” in binary form. As this should make clear then, the actual value stored for the allele in the vector does not necessarily have to be the digital asset disposition value, but only a value from which the digital asset disposition value can be calculated. In a preferred embodiment, alleles are represented by 32-bit unsigned integers. The use of unsigned integers as the alleles has an advantage that it helps avoiding epistasis, which is the inherent problem in genetic algorithms whereby a genome representation inhibits a genetic algorithm from finding an optimum solution to a problem.

Floating-point numbers may be used as the alleles according to another embodiment. In this case, the alleles will be a real floating-point number between 0 and 1 (including 0 and 1), and directly represent the digital asset disposition value. The use of real floating-point numbers as the alleles has an advantage that there is no need to convert each allele from its integer-numerator form to its floating-point form every time the allele is used in the genetic algorithm.

Thereafter, the fitness of the genomes in the genome population is determined by the asset manager 156 to obtain a fitness score. Determining the fitness of a genome is equivalent to determining how close the genome comes to optimizing or satisfying the user-specified criteria when the solution represented by the genome is applied to the initial digital asset portfolio. Again, the criteria themselves may include generating a target amount of cash from the digital asset portfolio.

According to one embodiment, the fitness scores of the genomes in the genome population are determined by (i) obtaining a composite genome criteria value for each genome in the genome population with a criteria function that encompasses the criteria, and (ii) computing a fitness score F for each genome by applying a fitness function to the composite genome criteria value corresponding to each genome. The fitness function will be described below.

The composite genome criteria value for each genome in the genome population is calculated by first applying the evaluated genome to the initial digital asset portfolio and using the respective criteria functions, to compute the criteria values for each underlying criteria (e.g., amount of cash generated, tax, commission, etc.). That is, for each criteria, there is a criteria function to which the disposition of the digital assets defined in the genome is applied; the result of the each criteria function is the criteria value. Then, the criteria values from all of the functions are normalized and standardized to obtain a normalized, standardized criteria value for each underlying criterion. Finally, the normalized, standardized criteria values are weighted and summed by a composite criteria function to obtain a composite genome criteria value corresponding to the evaluated genome.

The criteria values for each underlying criterion may be calculated by applying the genome to the initial digital asset portfolio in order to assess the impact of the transactions represented by the evaluated genome upon the various criteria. Each criterion is associated with a criteria value. The best (optimum) and worst criteria values corresponding to each underlying criterion may also be calculated by analyzing the nature of the underlying criterion.

Also, the criteria values for each underlying criterion are normalized (a value between 0 and 1) and standardized (optimal value is 0, worst value is 1) to generate normalized, standardized criteria values. Normalization and standardization of the criteria values allow the different values/scales of each criteria value corresponding to different criteria (e.g., minimum tax and minimum commission) to be summed together, because they are now unitless relative values, not dollar values or other application-specific values any more.

The normalization and standardization of the criteria values may be done in a different manner for different criteria by analyzing the nature of the criteria. For most criteria, the normalized, standardized criteria value can be computed by dividing the difference between the calculated criteria value and the best (or desired) criteria value by a normalization factor, which for most underlying criteria is the difference between the worst criteria value and the best criteria value. However, the normalization factor can be different depending upon the type of criterion to be optimized.

For example, asset manager 156 may calculate the normalized, standardized criteria value for the criterion of optimizing the amount of cash generated. Here, the desired amount of cash to be generated was input by a user through client application 122 as one of the criteria. The value of the most possible cash that can be generated from the initial digital asset portfolio can be obtained by calculating the total value of all digital assets in the portfolio if the value of the digital assets are already input through client application 122 by the user. Alternatively, the total value of all digital assets in the portfolio may be obtained by retrieving the current values of each digital asset in the user's portfolio from distributed system 140. The cash generated for each digital asset may be obtained by multiplying the price per unit digital asset (e.g., obtained from distributed system 140) with the total number of units and the percentage of the digital asset to be sold as represented by each allele of the genome. The normalized, standardized criteria value may then be calculated as described above.

Another criterion for which a normalized, standardized criteria value may be calculated is the minimization of capital gains. Here, the sum of the capital gains from all digital assets which when sold would generate a gain, without considering taxes, commission, etc. and the sum of capital loss from all digital assets which when sold would generate a loss, without considering taxes, commission, etc. may be calculated by using the initial digital asset portfolio and asset valuation data input through client application 122 or retrieved from distributed system 140. A capital gain is generated when the current value is higher than the basis for the digital asset and a capital loss is generated when the current value is lower than the basis for the digital asset. The basis of each digital asset may be included in the initial digital asset portfolio data. In order to calculate the total capital gain generated from the digital asset portfolio when the evaluated genome is applied to the portfolio, each allele in the evaluated genome is applied to each digital asset, and a capital gain is determined if the current sales price exceeds the basis and a capital loss if the current sales price is lower than the basis. Summation of all the capital gains and capital losses for the digital assets results in the total generated capital gain. The normalized, standardized criteria value may then be calculated as described above.

Another criterion for which a normalized, standardized criteria value may be calculated is the minimization of tax. Here, the maximum tax incurred when all digital assets showing a capital gain are sold may be calculated by applying the appropriate tax law to the maximum capital gain. The appropriate tax laws may be determined by asset manager 156 based on the user's information (e.g., geographic location, income, etc.), such as by retrieving the relevant tax laws from a remote database (e.g., maintained by the government). In some embodiments, the tax laws for various jurisdictions may be preprogrammed into asset manager 156. The maximum tax incurred when all digital assets showing a capital gain are sold is obtained by applying the appropriate tax law to the results of the change in the digital asset portfolio when the genome is applied to the digital asset portfolio. The tax calculation can also be done by finance management applications such as Intuit Inc.'s QUICKEN® or Microsoft Corp.'s MONEY®. The normalized, standardized criteria value may then be calculated as described above.

Normalized, standardized criteria values may be calculated for a plurality of other criteria as well, such as minimizing the commission (costs) for the transactions, minimizing the total number of transactions, favoring sale by whole lots, minimizing regret value, obtaining a target capital gain, maximizing return on investment (ROI), and the like.

In some embodiments, the user may specify as a criterion that the user's portfolio of digital assets is to be optimized based on predicted performance of digital assets. Asset manager 156 may predict the performance of digital assets based at least on historical transaction data for each digital asset, which is maintained in the immutable digital ledger of distributed system 140. For example, asset manager 156 may analyze the historical performance of digital assets to identify trends and predict future performance of digital assets based on predetermined predictive rules. For example, if historical performance data stored in distributed system 140 shows a substantial drop in number of transactions and/or transaction fees for a digital asset, this may be a trend which indicates that the digital asset is failing (e.g., a cryptocurrency may be in the process of being phased out in order to be replaced by a new cryptocurrency). Furthermore, asset manager 156 may analyze transactions performed by scripts 157 (e.g., executed on nodes 152), as well as scripts running on remote systems, in order to identify trends which may be used for predictive purposes. For instance, if there is a surge in “buy” or “sell” orders for a particular digital asset, asset manager 156 may take this as an indication that the value of this digital asset will continue to increase or decrease. A normalized, standardized criteria value may be calculated for this criterion in a manner similar to that described above with respect to other types of criteria.

After the standardized, normalized criteria values for the respective underlying criteria are calculated by asset manager 156 for the evaluated genome, the composite genome criteria value for the evaluated genome can be determined. For example, the normalized, standardized criteria value for each criterion may be multiplied by a weight value corresponding the relative weight of the criterion (e.g., based on weights specified by the user), and then these weighted criteria values for all criteria may be added together. The weights are importance levels (either predetermined or specified by the users) in the range of 0 to 1 and are normalized so that they add up to 1. Each weight corresponds to each criterion. Since the standardized, normalized criteria values are normalized and standardized values, a composite genome criteria value of zero (0) is the best (optimum) value and one (1) is the worst value.

In the manner described above, the composite genome criteria values corresponding to all the genomes in the genome population are determined. Thereafter, the fitness score for each genome in the genome population is obtained by applying a fitness function to each composite genome criteria value corresponding to each genome in the genome population. The fitness function is applied to the composite genome criteria values to redistribute the genomes in the solution space such that the genomes are distributed in a way more effective for the genetic algorithm. According to one embodiment, the fitness score for each genome in the genome population can be obtained by sigma truncation.

In this manner, the fitness scores of all the genomes in the genome population can be determined. The fitness scores of all the genomes are also in the range of 0 to 1.

After the fitness scores of all the genomes in the genome population are calculated, asset manager 156 determines whether or not one or more termination criteria are satisfied. The termination criteria may include such circumstances as: (i) at least one of the genomes in the genome population represents a digital asset disposition plan for digital assets in the initial digital asset portfolio such that the disposition of each digital asset in accordance with the alleles in the genome most nearly optimizes the criteria (including generation of target amount of cash); (ii) the number of generations for modifying the genome population has exceeded a certain limit applicable to modifying one genome population; (iii) the highest ranking genome's fitness is reaching or has reached a plateau such that successive generations no longer produce better results; and (iv) an allocated budget of either money, time, or computing resources has been expended.

The user may specify how nearly the criteria should be optimized by asset manager 156. For example, the user can specify a threshold amount for the amount of cash generated, and when the cash generated by the genome exceeds the threshold amount, then the termination criterion is satisfied. Likewise, the user can specify a threshold fitness score, and when the fitness score of at least one of the genomes in the genome population is lower than the threshold fitness score, the termination criterion is satisfied.

If one of the termination criteria is satisfied, the results are reported (e.g., to the user through client application 122) and stored (e.g., in data store 164), and the chosen solution may be implemented (e.g., by one or more scripts 157) in order to perform the relevant transactions to optimize the user's portfolio of digital assets. The user may be prompted to confirm implementing the solution before any transactions are performed. If no termination criterion has been satisfied, then it is determined whether or not the execution time applicable to the entire genetic algorithm of the application has exceeded a certain limit. If so, then the process may be returned to the user with the current best results. If not, the process returns to initialize the genome population again and restarts the genetic algorithm. According to one embodiment, a user imposes this time limit for the entire genetic algorithm of the application. In another embodiment, this time limit is predetermined in the asset manager 156 itself.

If the termination criteria are not satisfied and the genetic algorithm continues, asset manager 156 proceeds to select genomes for mating. The selection can be carried out by roulette wheel selection, tournament selection, or any other type of selection method typically used by genetic algorithms.

According to one embodiment, roulette wheel selection is used to give every genome in the genome population a chance of mating, the chance of mating for each genome being proportional to the determined fitness score of each genome. To this end, the fitness score Fⱼ for genome j is used as a threshold and a random number R in the range of 0 to 1 is selected. According to one embodiment where the fitness scores are standardized such that the best value is 0, the genome is selected for mating if R>Fⱼ. Otherwise the genome is skipped. Because very good genomes will have very low Fⱼ's, R will more likely be greater than their fitness Fⱼ. Very poor genomes are less likely to be picked. Roulette wheel selection is continued until the genetic algorithm module has selected two mating genomes from the genome population.

According to another embodiment, tournament selection is used for selecting the mating genomes. Specifically, a first superior genome is selected from a first set of two randomly chosen genomes in the initial genome population. Then, a second superior genome is additionally selected from a second set of two randomly chosen genomes in the initial genome population. The first and second superior genomes are the selected genomes for mating. Superiority of each genome is determined based on the fitness score for each genome computed above. Tournament selection is continued until the genetic algorithm module has selected two mating genomes from the genome population.

Thereafter, the two selected genomes are mated by asset manager 156 to create offspring genomes. According to one embodiment, the selected genomes are mated by single-point crossover. Single-point crossover is performed by randomly selecting a common crossover point (bit) in a first mating genome and a second mating genome among the selected mating genomes. The first mating genome has a first portion and a second portion divided by the common crossover point and the second mating genome also has a first portion and a second portion divided by the common crossover point. Then, the second portion of the first mating genome is replaced with the second portion of the second mating genome to create an offspring genome.

In accordance with another embodiment, two-point crossover is used for mating. Two-point crossover is performed by selecting two crossover points (here, bit positions in the genome), copying the part from the beginning of the genome to the first crossover point from the first mating genome, copying the part from the first to the second crossover point from the second mating genome, and copying the part from the second crossover point to the end of the genome from the first mating genome, so as to create an offspring genome.

In accordance with still another embodiment, uniform crossover is used for mating. Uniform crossover is performed by randomly copying from either the first mating genome or the second mating genome to create an offspring genome. That is, the length of the genome is traversed and at each bit location a bit is copied into the offspring genome from either the first mating genome or the second mating genome.

According to still another embodiment, arithmetic crossover is used for mating. Arithmetic crossover is carried out by performing some arithmetic operation with the first and second mating genomes to create an offspring genome. For example, the first and second mating genomes represented by binary bits are added to obtain the offspring genome.

Thereafter, the offspring genomes are mutated at a low frequency by asset manager 156. According to one embodiment, the mutation rate is 0.01%, and this is implemented by selecting a single integer in the range of 1 to 10,000, and mutating only when a randomly selected number in the range equals the selected integer. Another approach is to set the mutation rate as the threshold itself, and mutate the bit only if a randomly selected number is below the threshold. The low frequency mutation rate is selected such that it is high enough for the genetic algorithm to explore the solution space effectively but low enough to prevent destruction of information obtained during mating. Mutation is carried out by (i) selecting a bit in the offspring genome to mutate by random selection in a uniform distribution, and (ii) changing the selected bit in the offspring genome from zero (0) to one (1), or vice versa.

Thereafter, the offspring genomes are inserted into the genome population and a new generation genome population is obtained based on a replacement strategy by asset manager 156. According to one embodiment, the replacement strategy adds the offspring genome to the initial genome population to obtain a modified genome population. Then, the fitness score of each genome in the modified genome population is determined in the manner described above. Thereafter, a first predetermined number of the worst vectors are removed from the modified genome population based upon the determined fitness of the modified genome population. Finally, a second predetermined number of the best vectors in the initial genome population may be added to the modified genome population based upon the determined fitness of the initial genome population. The resultant modified genome population is the new (next generation) genome population. According to one embodiment, the first and second predetermined numbers above are 25.

Then, the process returns to determine the fitness of the new genome population as described above. These processes are repeated until one or more of the termination criteria are satisfied.

In some embodiments, asset manager 156 may also use techniques described herein to determine new digital assets to add to the user's portfolio in accordance with the criteria specified by the user. Because new digital assets frequently become available (e.g., through “initial coin offerings”), the use of genetic algorithms on a distributed system may make it possible to select the ideal portfolio of digital assets, taking into account a vast and frequently changing set of possibilities. For example, a user may specify a particular type of digital assets (e.g., cryptocurrencies) or leave open the possibility of all types of digital assets so that asset manager 156 can locate the ideal combination of digital assets to satisfy the user's criteria. Adding new digital assets to the user's portfolio may require some changes to the format of the genomes. For example, instead of each genome comprising one allele for each digital asset in the initial asset portfolio, each genome may instead comprise a series of pairs, a pair comprising an identifier (e.g., a name) of a digital asset and a value corresponding to the percentage of the user's portfolio which is to be made up by the digital asset. Other genome formats which allow a plurality of digital assets to be identified in association with values may be used as well. Asset manager 156 may identify a plurality of possible digital assets by analyzing digital assets 145 of distributed system 140 and other digital assets available on different remote systems. The genetic algorithm described above may then be employed to identify an optimal solution, involving the purchase of new digital assets, which best satisfies the user's criteria.

The asset manager 156, by using genetic algorithms on a distributed system such as a blockchain, is able to search an enormous, non-linear search space with a number of inter-dependent variables to find a near optimal solution for optimizing or satisfying numerous criteria specified by the user. Numerous (possibly conflicting) criteria can be weighted by the importance levels and optimized at the same time. The criteria can include generating a target amount of cash. Moreover, the asset manager 156 is not limited to a certain type of digital asset and can be used with any type of digital assets in a digital asset portfolio. In addition, the solution can be found in an acceptable period of time, such as a few seconds to a few minutes.

It is also possible to use multiple different genome populations as the initial genome populations and run them simultaneously according to the genetic algorithm, rather than use one initial genome population. For example, one embodiment utilizes a plurality of genome populations in parallel, each handled by a different node 152 of distributed system 150. This results in a reduction of the time required for finding the solution and an efficient distribution of processing among the various nodes 152 that run the genetic algorithm.

Distributed system 160 comprises a plurality of nodes 162a-n which, together, comprise a data store 164. In some embodiments, distributed system 160 is a blockchain. In other embodiments, distributed system 160 comprises a distributed data store (e.g., InterPlanetary File System (IPFS), Storj etc.). Use of a distributed data store that is not a blockchain may be beneficial, as storing large amounts of data on a blockchain may be associated with significant costs. Data store 164 may contain user data, such as user profiles, user criteria, solution data (e.g., the results of the genetic algorithms executed by asset manager 156), and digital asset portfolio data. In some embodiments, user data may be secured using credentials such as usernames and passwords or ECDSA private keys, and users may provide these credentials to asset manager 156 to enable access to their user data.

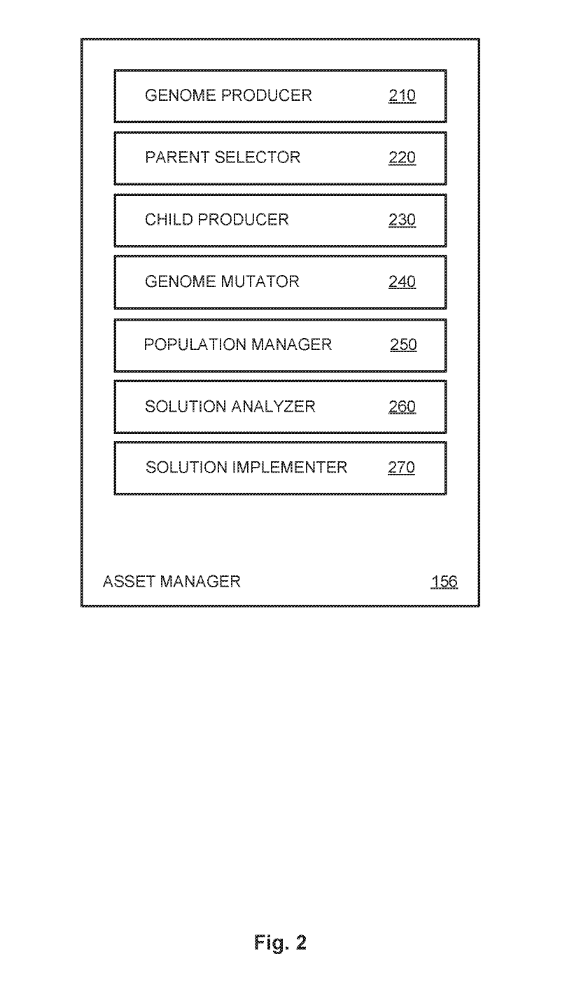

FIG. 2 further illustrates the asset manager 156 described relative to FIG. 1, according to one embodiment. As shown, the asset manager 156 comprises a genome producer 210, a parent selector 220, a child producer 230, a genome mutator 240, a population manager 250, a solution analyzer 260, and a solution implementer 270. Each of these components may perform functions of asset manager 156 associated with techniques described above.

For example, genome producer 210 may initialize the genome population, generating new genomes (e.g., at random, including certain fixed genome values at the edges of the solution space, etc.) in accordance with techniques described above with respect to FIG. 1. Parent selector 220 may choose parents for mating out of the genome population, such as by roulette wheel selection, tournament selection, and the like. Child producer 230 may perform mating operations in order to produce offspring from two parent genomes, such as by single-point crossover, two-point crossover, uniform crossover, arithmetic crossover, and the like. Genome mutator 240 may mutate offspring produced by child producer 230, such as by selecting and changing bits. Population manager 250 may perform operations related to adding and removing genomes from the genome population, such as removing a predetermined number of worst genomes (e.g., based on fitness scores) and adding a predetermined best number of genomes. Solution analyzer 260 may perform operations related to determining the optimal solution from the genome population, such as calculating normalized, standardized criteria values, composite genome criteria values, fitness scores, and identifying whether termination criteria have been met.

Solution implementer 270 may perform operations related to implementing an identified optimal solution. For example, solution implementer 270 may use scripts 157 (e.g., smart contracts) to perform transactions in accordance with the chosen solution in order to optimize the user's portfolio of digital assets. If the chosen solution (genome) comprises buying, selling, and/or trading certain units of various digital assets, for instance, solution implementer 270 may execute scripts 157 which buy, sell, and/or trade these units. In some embodiments, solution implementer 270 may identify existing scripts 157 which perform these transactions, and execute these scripts 157. In other embodiments, solution implementer 270 may generate and execute new scripts 157 to perform these transactions, or may execute the transactions directly (e.g., by directly sending “buy”, “sell”, and/or “trade” orders to distributed system 140 with respect to digital assets 145). In some embodiments, solution implementer 270 waits to implement a given solution until user confirmation is received (e.g., via client application 122).

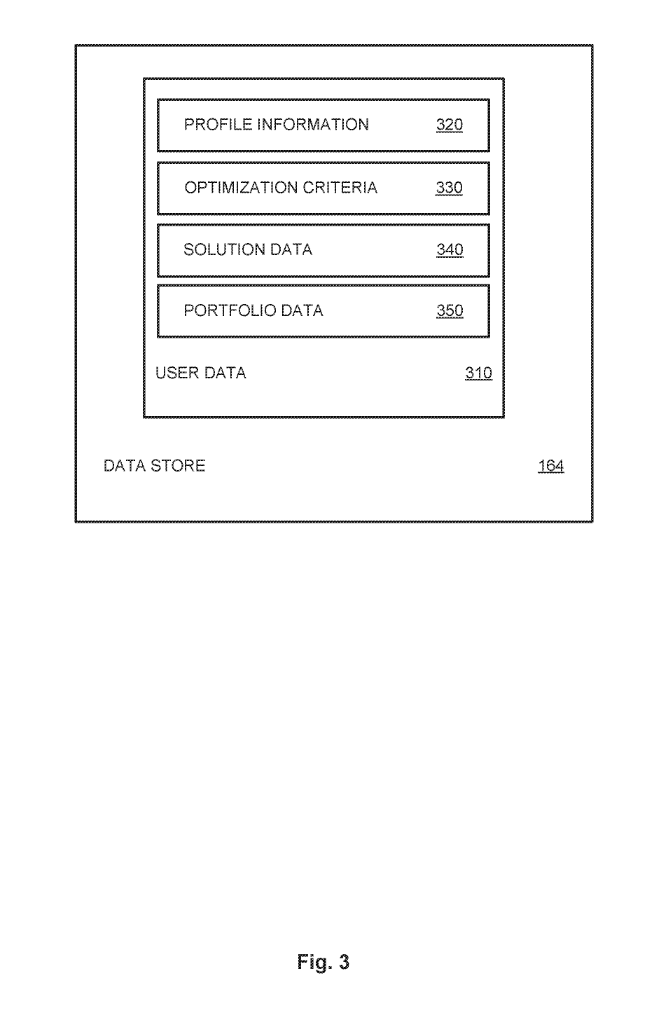

FIG. 3 further illustrates the data store 164, described relative to FIG. 1, according to one embodiment. As shown, the data store 164 includes user data 310 (exemplary of user data for a plurality of users), which comprises profile information 320, optimization criteria 330, solution data 340, and portfolio data 350. In some embodiments, user data 310 is received from a user via client application 122 (e.g., in response to prompts associated with a workflow for establishing and optimizing a portfolio of digital assets).

Profile information 320 may comprise information about the user, such as geographic location, age, gender, income, and the like. Optimization criteria 330 may comprise the criteria specified by the user for optimization of the user's profile of digital assets, such as target cash value, maximum tax liability, and the like. Solution data 340 may comprise information resulting from the genetic algorithm run by asset manager 156, such as the optimal disposition of the user's digital asset portfolio, and any other information which asset manager 156 may store for future use. Portfolio data 350 may comprise information describing the user's portfolio of digital assets, such as an identifier of the user's portfolio, identities and values of the user's digital assets, public key (commonly called address), and the like.

Data store 164 may be accessible by asset manager 156 so that the user data 310 may be used in connection with techniques for employing genetic algorithms on a distributed system for optimizing a user's portfolio of digital assets.

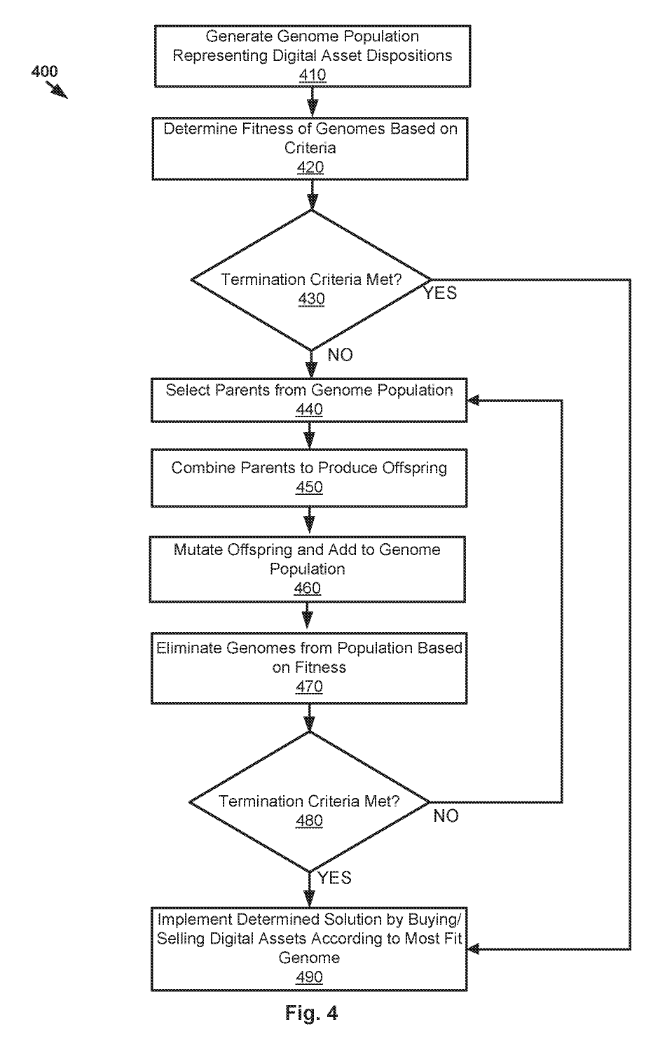

FIG. 4 illustrates example operations 400 associated with techniques described herein for optimization of a portfolio of digital assets. Operations 400 may be performed, for instance, by asset manager 156.

At step 410, asset manager 156 generates a genome population representing digital asset dispositions. For example, the genome population may comprise a plurality of randomly generated vectors, each of which represents a set of digital assets and associated values corresponding to amounts of the digital assets to be bought, sold, and/or traded.

At step 420, asset manager 156 determines the fitness of the genomes in the genome population. For example, asset manager 156 may calculate normalized, standardized criteria values based on the user-defined criteria and information about the digital assets (e.g., values obtained from distributed system 140), calculate composite genome criteria values, and then calculate fitness scores by applying a fitness function (e.g., sigma truncation) to the composite genome criteria values.

At step 430, asset manager 156 determines whether one or more termination criteria have been met. For example, termination criteria may be specified by a user and/or predetermined within asset manager 156, and may include whether a genome has been found that satisfies a minimum criteria, whether a fixed number of generations has been reached, whether an allocated budget of computation time/money/resources has been reached, whether the highest ranking genome's fitness is reaching or has reached a plateau such that successive iterations no longer produce better results, and the like. If a termination criterion has been met, operations continue at 490 where the optimal solution is implemented according to the most fit genome in the population. Otherwise, operations continue at step 440.

At step 440, asset manager 156 selects parents for mating from the genome population. For example, asset manager 156 may use a technique such as roulette wheel selection or tournament selection to identify two genomes which are to be combined in order to produce offspring.

At step 450, asset manager 156 combines the selected parents to produce one or more offspring. For example, asset manager 156 may use one or more of single-point crossover, two-point crossover, uniform crossover, or arithmetic crossover to mate the parent genomes and generate child genomes.

At step 460, asset manager 156 mutates the offspring and adds them to the genome population. Mutation may involve, for example, selecting a bit of a genome and changing it from 0 to 1 or from 1 to 0.

At step 470, asset manager 156 eliminates one or more genomes from the genome population according to the fitness of the genomes. For example, asset manager 156 may eliminate a fixed number of genomes with the worst fitness scores from the population.

At 480, asset manager 156 again determines whether one or more termination criteria have been met. For example, termination criteria may include whether a genome has been found that satisfies a minimum criteria, whether a fixed number of generations has been reached, whether an allocated budget of computation time/money/resources has been reached, whether the highest ranking genome's fitness is reaching or has reached a plateau such that successive iterations no longer produce better results, and the like. If a termination criterion has been met, operations continue at 490 where the optimal solution is implemented according to the genome in the population with the best fitness score. Otherwise, operations return to step 440 in order to begin another generation.

At step 490, asset manager 156 implements the determined solution by performing transactions related to digital assets according to the genome with the best fitness score. In some embodiments, asset manager 156 waits until the user approves the solution before performing transactions. Asset manager 156 may, for example, use scripts 157 to execute transactions and optimize the user's portfolio of digital assets according to the genome with the best fitness score.

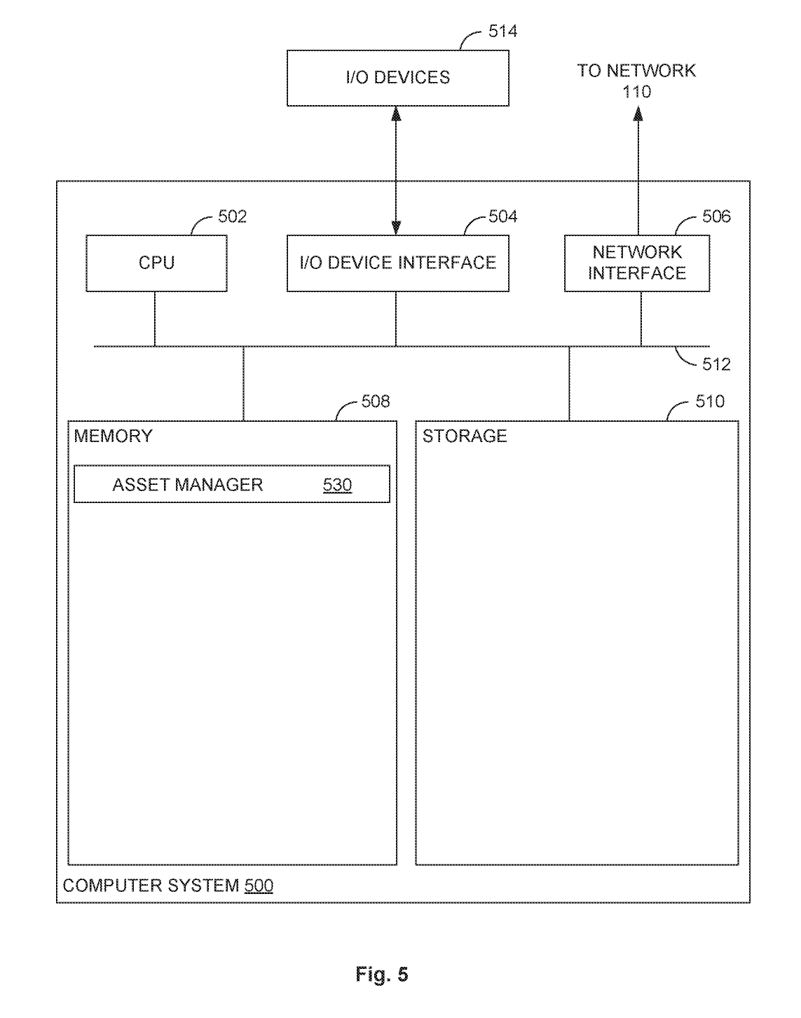

FIG. 5 illustrates an example computing system 500 used to optimize a user's portfolio of digital assets, according to one embodiment. In some embodiments, computer system 500 is representative of a single node 152 of distributed system 150. Aspects of computer system 500 may also be representative of other devices used to perform techniques described herein (e.g., nodes 142, nodes 162, and client device 120).

As shown, the computing system 500 includes, without limitation, a central processing unit (CPU) 505, a network interface 515, a memory 520, and storage 530, each connected to a bus 517. The computing system 500 may also include an I/O device interface 510 connecting I/O devices 512 (e.g., keyboard, display and mouse devices) to the computing system 500. Further, the computing elements shown in computing system 500 may correspond to a physical computing system (e.g., a system in a data center) or may be a virtual computing instance executing within a computing cloud.

The CPU 505 retrieves and executes programming instructions stored in the memory 520 as well as stored in the storage 530. The bus 517 is used to transmit programming instructions and application data between the CPU 505, I/O device interface 510, storage 530, network interface 515, and memory 520. Note, CPU 505 is included to be representative of a single CPU, multiple CPUs, a single CPU having multiple processing cores, and the like, and the memory 520 is generally included to be representative of a random access memory. The storage 530 may be a disk drive or flash storage device. Although shown as a single unit, the storage 530 may be a combination of fixed and/or removable storage devices, such as fixed disc drives, removable memory cards, optical storage, network attached storage (NAS), or a storage area-network (SAN).

Illustratively, the memory 520 includes an asset manager 530, which performs operations related to optimizing a user's portfolio of digital assets, according to techniques described herein. For example, asset manager 530 may be equivalent to asset manager 156 in FIG. 1, and may use genetic algorithms to determine an optimal disposition of a user's digital assets according to criteria defined by the user.

Advantageously, the techniques presented herein allow for an optimal solution to be efficiently identified from a very large solution space based on user-defined criteria for optimizing a portfolio of digital assets. Use of distributed systems such as blockchains allows for computations to be distributed across a plurality of computing systems in order to use resources more efficiently and improve solution turnaround time significantly.

In the preceding, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples a computer readable storage medium include: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible medium that can contain, or store a program.

While the foregoing is directed to embodiments of the present disclosure, other and further embodiments of the disclosure may be devised without departing from the basic scope thereof, and the scope thereof is determined by the claims that follow.

What is claimed is:

1. A computer-implemented method for managing digital assets, comprising:
receiving one or more optimization criteria from a user for optimizing a portfolio of digital assets;
generating a genome population comprising a plurality of genomes, each of which represents a solution for optimizing the portfolio of digital assets;
selecting and mating two parent genomes from the genome population to produce a child genome;
mutating the child genome;
adding the child genome to the genome population;
removing a number of genomes from the genome population;
determining, based on the one or more optimization criteria, whether any genome in the genome population represents an optimal solution;
upon determining that a genome in the genome population represents an optimal solution, performing at least one of buying, selling, and trading of digital assets according to the solution represented by the genome.

2. The computer-implemented method of claim 1, wherein the generating, selecting, mating, mutating, adding, removing, and determining are performed by a distributed system comprising a plurality of computing devices connected over a network.

3. The computer-implemented method of claim 1, wherein the digital assets comprise at least one type of cryptocurrency.

4. The computer-implemented method of claim 1, wherein each genome comprises a vector.

5. The computer-implemented method of claim 1, wherein the mating of the two parent genomes to produce a child genome comprises performing at least one of: single-point crossover; two-point crossover; uniform crossover; and arithmetic crossover.

6. The computer-implemented method of claim 1, wherein the determining, based on the one or more optimization criteria, whether any genome in the genome population represents an optimal solution comprises:
calculating, based on the one or more optimization criteria, a fitness score for each genome in the genome population;
determining if a genome in the genome population has a fitness score which reaches a threshold.

7. The computer-implemented method of claim 1, wherein the buying or selling of digital assets is performed using one or more smart contracts executed by a Turing-complete virtual machine.

8. The computer-implemented method of claim 1, further comprising:
upon determining that no genome in the genome population represents an optimal solution:
selecting another two parent genomes from the genome population;
mating the two parent genomes to produce a child genome;
mutating the child genome;
adding the child genome to the genome population;
removing a number of genomes from the population;
determining, based on the one or more optimization criteria, whether any genome in the genome population represents an optimal solution.

9. A computing device for managing digital assets, the computing device comprising:
a memory; and
a processor configured to perform a method for managing digital assets, comprising:
receiving one or more optimization criteria from a user for optimizing a portfolio of digital assets;
generating a genome population comprising a plurality of genomes, each of which represents a solution for optimizing the portfolio of digital assets;
selecting and mating two parent genomes from the genome population to produce a child genome;
mutating the child genome;
adding the child genome to the genome population;
removing a number of genomes from the genome population;
determining, based on the one or more optimization criteria, whether any genome in the genome population represents an optimal solution;
upon determining that a genome in the genome population represents an optimal solution, performing at least one of buying, selling, and trading of digital assets according to the solution represented by the genome.

10. The computing device of claim 9, wherein the generating, selecting, mating, mutating, adding, removing, and determining are performed by a distributed system comprising a plurality of computing devices connected over a network.

11. The computing device of claim 9, wherein the digital assets comprise at least one type of cryptocurrency.

12. The computing device of claim 9, wherein each genome comprises a vector.

13. The computing device of claim 9, wherein the mating of the two parent genomes to produce a child genome comprises performing at least one of: single-point crossover; two-point crossover; uniform crossover; and arithmetic crossover.

14. The computing device of claim 9, wherein the determining, based on the one or more optimization criteria, whether any genome in the genome population represents an optimal solution comprises:
calculating, based on the one or more optimization criteria, a fitness score for each genome in the genome population;
determining if a genome in the genome population has a fitness score which reaches a threshold.

15. The computing device of claim 9, wherein the buying or selling of digital assets is performed using one or more smart contracts executed by a Turing-complete virtual machine.

16. The computing device of claim 9, wherein the method further comprises:
upon determining that no genome in the genome population represents an optimal solution:
selecting another two parent genomes from the genome population;
mating the two parent genomes to produce a child genome;
mutating the child genome;
adding the child genome to the genome population;
removing a number of genomes from the population;
determining, based on the one or more optimization criteria, whether any genome in the genome population represents an optimal solution.

17. A computer-readable medium comprising instructions that when executed by a computing device cause the computing device to perform a method for managing digital assets, the method comprising:
receiving one or more optimization criteria from a user for optimizing a portfolio of digital assets;
generating a genome population comprising a plurality of genomes, each of which represents a solution for optimizing the portfolio of digital assets;
selecting and mating two parent genomes from the genome population to produce a child genome;
mutating the child genome;
adding the child genome to the genome population;
removing a number of genomes from the genome population;
determining, based on the one or more optimization criteria, whether any genome in the genome population represents an optimal solution;
upon determining that a genome in the genome population represents an optimal solution, performing at least one of buying, selling, and trading of digital assets according to the solution represented by the genome.

18. The computer-readable medium of claim 17, wherein the generating, selecting, mating, mutating, adding, removing, and determining are performed by a distributed system comprising a plurality of computing devices connected over a network.

19. The computer-readable medium of claim 17, wherein the digital assets comprise at least one type of cryptocurrency.

20. The computer-readable medium of claim 17, wherein each genome comprises a vector.

21. The computer-readable medium of claim 17, wherein the mating of the two parent genomes to produce a child genome comprises performing at least one of:
single-point crossover; two-point crossover; uniform crossover; and arithmetic crossover.

22. The computer-readable medium of claim 17, wherein the determining, based on the one or more optimization criteria, whether any genome in the genome population represents an optimal solution comprises:
calculating, based on the one or more optimization criteria, a fitness score for each genome in the genome population;
determining if a genome in the genome population has a fitness score which reaches a threshold.

23. The computer-readable medium of claim 17, wherein the buying or selling of digital assets is performed using one or more smart contracts executed by a Turing-complete virtual machine.

24. The computer-readable medium of claim 17, wherein the method further comprises:
upon determining that no genome in the genome population represents an optimal solution:
selecting another two parent genomes from the genome population;
mating the two parent genomes to produce a child genome;
mutating the child genome;
adding the child genome to the genome population;
removing a number of genomes from the population;
determining, based on the one or more optimization criteria, whether any genome in the genome population represents an optimal solution.
